(19) United States
(12) Patent Application Publication
(10) Pub. No.: US 2008/0181429 A1
(43) Pub. Date: Jul. 31, 2008

(54) Durable and/or waterproof music earwear for helmets/headgear

(76) Inventor: Lance Fried, San Diego, CA (US)

Correspondence Address: STETINA BRUNDA GARRED & BRUCKER, 75 ENTERPRISE, SUITE 250, ALISO VIEJO, CA, 92656, US

(21) Appl. No.: 11/698,554

(22) Filed: Jan. 26, 2007

(51) Int. Cl. H04R 1/02

(52) U.S. Cl. 381/87

(57) ABSTRACT

A sound system is provided which may be removably attachable to a variety of head gears despite the size, manufacturer or type of head gear. In particular, the sound system may be attached to an ear pad. The ear pad may have a first attachment mechanism and a second attachment mechanism. The ear pad may have an elastic portion disposed between the first and second attachment mechanisms such that a distance between the first and second attachment mechanisms may be enlarged or increased to match mating attachment mechanisms formed on the head gear. A swim cap having a sound system is provided such that a swimmer may listen to audio sounds while swimming. The sound system may be retained adjacent to the wearer's ears via attachment to the swim cap, a compressive force created by the swim cap, and/or a physical member hooked around the wearer's ears.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates generally to a sound system attached to and or within a head gear.

Numerous sports and activities require the participant to wear a head gear such as a helmet or a swim cap. Helmets are typically worn by snowboarders and cyclists to protect their heads in the event that they crash into a hard object. Swim caps are typically worn by swimmers to keep water out of the swimmer's hair.

Snowboarders may purchase helmets which have an integrated sound system such that the snowboarder may listen to his/her favorite music while snowboarding. Over a period of time, the sound system may fail to operate properly due to crashes, water exposure resulting in rust or short circuits, and other issues that may arise over a period of time. Once the sound system fails, the wearer must either purchase an entire new helmet with integrated sound system or purchase a replacement sound system, if available. Unfortunately, a new helmet with integrated sound system may be expensive. A replacement sound system may be purchased at a reduced rate. However, the user is limited to the particular replacement sound system designated by the manufacturer of the helmet. The reason is that manufacturers typically build helmets to fit their sound systems. As such, the replacement sound system may be difficult to find or unsatisfactory.

Swimmers also enjoy listening to music and other audio sounds while swimming. Prior art sound systems have been produced which clip to the swimmer's goggles. Other prior art sound systems have been produced which are secured to the swimmer's ears. Unfortunately, these prior art sound systems are cumbersome and may not be able to project the sound from the speakers of the sound system into the swimmer's ears in an optimal manner. Moreover, prior art sound systems for swimmers tend to dislodge from the swimmer's head. By way of example and not limitation, the speakers of the sound system would shift away from the swimmer's ear thereby producing a low quality audio sound. Also, the speakers may shift away from the swimmer's ear such that the swimmer is unable to hear any audio sounds.

Another deficiency in prior art sound systems is that the speaker wires (i.e., wires that extend between speakers and audio player) tend to hinder the wearer's required movement in an activity. For example, wearer may carry the audio player in his/her jacket. The speaker wires will extend from the wearer's jacket to the wearer's ears. Unfortunately, the wires tend to interfere with the wearer's required movement. Additionally, if the wearer removes his/her jacket, the wearer must carefully remove his/her jacket to ensure that the speaker wires are not tangled. Also, when the wearer puts on his/her jacket, the wearer must re-route the speaker wires so as to interfere minimally with the movement of the wearer while participating in the activity. Prior art devices have attempted to alleviate this problem by providing a wireless communication from the audio player to the speakers. However, such wireless communication systems are expensive. Additionally, wireless communications consumes more energy compared to wired communication systems. As a result, the wearer is not able to enjoy his/her favorite music for a long duration of time.

Currently walkers and runners may enjoy their favorite music by wearing an armband that holds the audio player with the speaker wires extending from the armband to the wearer's ears. Unfortunately, the speaker wires may interfere with the wearer's required movement to walk and/or run.

### BRIEF SUMMARY

The present invention addresses the needs discussed above, discussed below and those that are known in the art.

By way of example and not limitation, a sound system may be permanently attached to an ear pad or removably attachable to the ear pad. The sound system may also be water resistant, water proof or suitable only for non-water related sports. The ear pad may be removably attachable to a variety of head gear despite the differences in the type of helmet, the manufacturer, the helmet size as well as other factors. To this end, a first attachment mechanism and a second attachment mechanism is attached to the ear pad. A distance between the first and second attachment mechanisms is adjustable (i.e., increased or decreased) such that the distance between the first and second attachment mechanisms may be matched to a distance between mating first and second attachment mechanisms formed on a selected head gear. By way of example and not limitation, the ear pad may have an elastic portion disposed between the first and second attachment mechanisms of the ear pad. The wearer may attach the first attachment mechanism of the ear pad to the mating first attachment mechanism of the head gear. The wearer may stretch the elastic portion of the ear pad until the second attachment mechanism may be attached to the mating second attachment mechanism of the head gear. Accordingly, the elastic portion of the ear pad allow for variations in the distance between the mating first and second mechanisms due to the helmet size, brand (i.e., manufacturer), helmet type, and other factors discussed herein and known in the art such that the ear pad may be connected to a variety of head gears.

Alternatively, instead of forming the elastic portion between the first and second attachment mechanisms in the ear pad, the second attachment mechanism may be attached to a strap which may be fixedly or pivotably attached to the ear pad. The strap may have the elastic portion which allows a distance between the first and second attachment mechanisms to be adjusted such that the ear pads may be mounted to a variety of head gears.

Alternatively, instead of mounting a strap with an elastic portion, a slotted strap may be mounted to the ear pad. The second attachment mechanism may be slidably mounted to the slotted strap. The slotted strap may be fixedly mounted or pivotably mounted to the ear pad. To adjust the distance between the first and second attachment mechanisms, the second attachment mechanism may be slid along the slotted strap and fixed to a particular longitudinal position on the slotted strap. The ear pad may be mounted to a variety of head gears by sliding and locking the second attachment mechanism along the slotted strap until the distance between the first and second attachment mechanisms is equal to the distance between the mating first and second attachment mechanisms of the head gear.

In an alternate embodiment, a sound system may be used in conjunction with a swim cap such that a swimmer may listen to music or other audio sounds while swimming. By way of example and not limitation, the swim cap may have a flap extension with the sound system attached thereto. The sound system may be encapsulated in a waterproof pouch. In use, the swim cap is placed over the swimmer's head. The flap extension is folded under the swim cap and the sound system is positioned adjacent to the swimmer's ear. The sound system is held in place by compression of the swim cap against the swimmer's head. Additionally, the sound system is held in place adjacent to the swimmer's ear via the attachment of the flap extension to the swim cap. The compression force of the swim cap and the attachment of the flap extension secures the sound system adjacent to the swimmer's ear such that the sound system will not shift while the swimmer is swimming. It is also contemplated that the flap extension may extend around the rear of the swimmer's head and form a guide for a speaker wire. Alternatively, it is contemplated that an ear holder be formed or attached to the flap extension for holding the speaker in position adjacent to the swimmer's ears while swimming.

The sound system may comprise a free standing waterproof pouch encapsulating the speaker. A head engaging surface of the waterproofed pouch may have a protrusion for locating and/or maintaining the position of the speaker adjacent the swimmer's ears while swimming. Additionally, or alternatively, the waterproof pouch may have an ear hook so as to hook the waterproof pouch about the ear of the swimmer. In use, the swimmer places the swim cap over his/her head. The left and right sides of the swim cap are lifted up. The waterproof pouch may be placed adjacent to each ear of the swimmer. The swim cap is then released and compresses the swim cap and sound system against the swimmer's head.

The sound system may be attached to a flexible and bendable head support frame. The sound system may be worn by the swimmer. The swim cap may be disposed over the swimmer's head and sound system to hold the sound system in place over the swimmer's ear. Alternatively, the sound system may be fixedly attached or slideably attached to a head band along a circumference of the head band.

The sound system may also be removably attachable to an interior surface or exterior surface of the swim cap via hooks and loops, snaps or other attachment mechanisms known in the art.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a side view of a head gear;

FIG. 2A is a schematic of an audio player wirelessly communicating with a sound system;

FIG. 2B is a schematic of an audio player communicating with a sound system via a speaker wire;

FIG. 3 is a side view of an ear pad with an elastic portion disposed between first and second attachment mechanisms to adjust a distance between the first and second attachment mechanisms to fit mating first and second attachment mechanisms formed on a variety of head gear;

FIG. 3A is an alternate method of attaching a speaker (e.g., ear bud) to an ear pad;

FIG. 4 is a side view of an ear pad with a stretchable strap for adjusting the distance of the first and second attachment mechanisms to fit the mating first and second attachment mechanisms of the head gear;

FIG. 5 is a side view of an ear pad with a slotted strap to adjust the distance between the first and second attachment mechanisms to fit the distance between the mating first and second attachment mechanisms of a variety of headgear;

FIG. 5A is a cross sectional view of the slotted strap and second attachment mechanism (e.g., snap fastener) shown in FIG. 5

FIG. 6 is a side view of a swim cap with an integrated sound system foldable under a head engaging portion such that a swimmer may listen to audio sounds while swimming;

FIG. 7 is a side view of a swim cap with an integrated sound system and a speaker wire guide;

FIG. 7A is a cross sectional view of the speaker wire guide;

FIG. 8 is a side view of a swim cap with an integral sound system foldable under the head engaging portion wherein the sound system has an ear holder for maintaining an optimal position of a speaker of the sound system adjacent the wearer's ears;

FIG. 9 is a side view of a stand alone sound system which may be used in conjunction with a standard swim cap wherein the sound system is held in place adjacent the wearer's ears by compression of the stretchable head engaging portion to the sound system and the wearer's head;

FIG. 9A is a cross sectional front view of the sound system shown in FIG. 9 illustrating a waterproofed enclosure for the speaker and a protrusion for aligning the speaker to the wearer's ear;

FIG. 10 is a stand alone sound system wherein the speaker of the sound system is held in place adjacent to the wearer's ear by an ear hook and compression of the sound system against the wearer's head by the stretchable head engaging portion;

FIG. 10A illustrates the sound system shown in FIG. 10;

FIG. 11 illustrates a standard head set with waterproof ear buds worn by a wearer and a standard swim cap placed over the standard head set with waterproof ear buds wherein a frame of the head set and compression of the head set to the wearer's head via the stretchable head engaging portion holds the ear buds in place adjacent the wearer's ears;

FIG. 11A is a perspective view of the head set shown in FIG. 11;

FIG. 12 illustrates a sound system held in place via a headband and compression of the swim cap against the sound system by a stretchable head engaging portion;

FIG. 12A illustrates a perspective view of the head band with the sound system shown in FIG. 10;

FIG. 12B illustrates a side view of a headband with a pouch for receiving a waterproof audio player;

FIG. 13 is a side view of a swim cap with a removably attachable sound system; and

FIG. 13A is a cross sectional view of the removeable sound system shown in FIG. 13.

### DETAILED DESCRIPTION

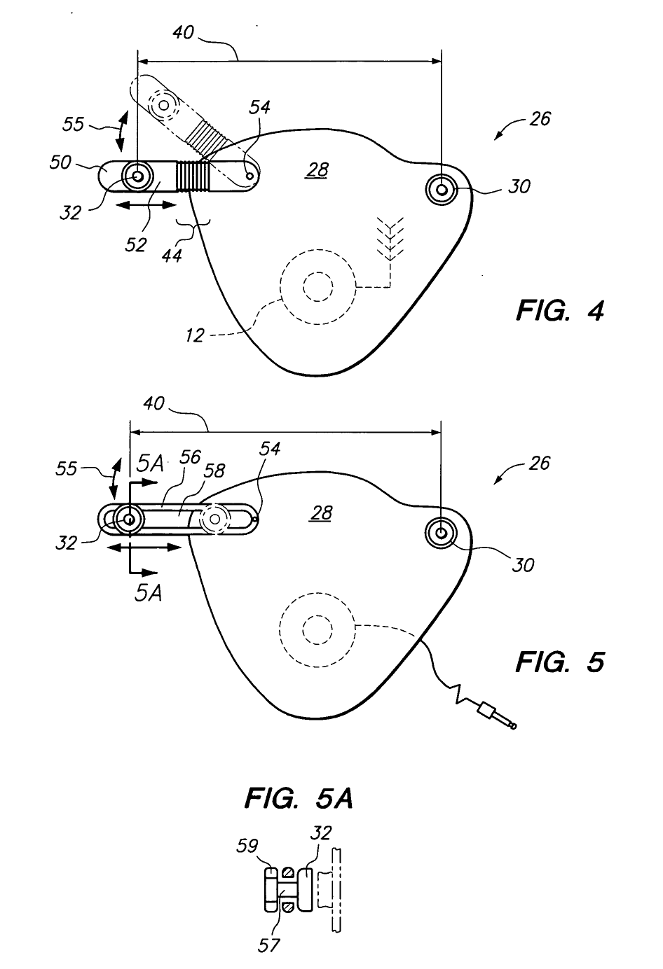

Referring now to the drawings, an ear pad sound system 10 for a variety of headgears is shown. FIGS. 1-3 will be discussed in relation to non-water related sports. Nonetheless, the various aspects of the ear pad sound system 10 shown in FIGS. 1-3 may be variously embodied and employed in water related sports. Likewise, FIGS. 4-11 illustrate a swim cap (i.e., water related sport) having an ear pad sound system 10. Although the ear pad sound system 10 shown in FIGS. 4-11 is discussed in relation to water related sports, it is also contemplated that the various aspects discussed in relation to FIGS. 4-11 may also be variously embodied and employed to non-water related sports. It is also contemplated that the various aspects of the sound system discussed herein may be employed in hats and beanies and other types of headgear.

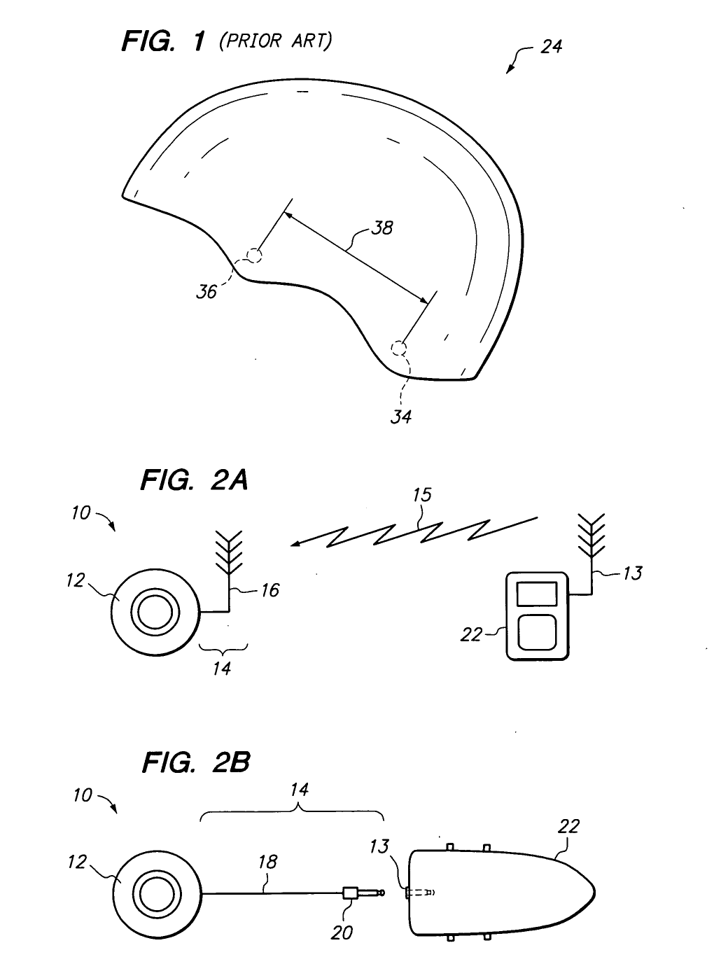

In use, the wearer may listen to his or her favorite music while swimming or while engaging in other vigorous physical activity (e.g., bicycle, snowboarding, skateboarding, etc.). For example, the wearer may wear an audio player 22 (see FIGS. 2A and 2B) having an output 13. The output 13 transmits an audio signal 15 to an input 14 of the sound system 10 which then plays the audio signal on the speaker 12 of the sound system. The audio signal may be communicated to the speaker 12 from the audio player via a wireless transmission (see FIG. 2A) or a wired transmission (see FIG. 2B). The wearer may wear a head gear such as a helmet (see FIG. 1) or a swim cap. The sound system 10 may be integral to the helmet or swim cap. Alternatively, the sound system may be removeably attachable to the helmet or swim cap. Whether the sound system is integral or removeably attachable to the helmet or swim cap, the speakers 12 of the sound system 10 may be disposed adjacent to the wearer's ears such that the wearer may listen to music or audio sounds while swimming or engaging in a vigorous physical activity.

Each of the ear pad sound systems 10 discussed herein may comprise at least one speaker 12. Typically, the ear pad sound system 10 will comprise left and right speakers 12a, b for the person's left and right ears, respectively. The sound system 10 discussed herein may discuss the sound system 10 in reference to a single ear for convenience. However, the sound system 10 is not to be limited to having a single speaker for either the left or right ear. Rather, the various aspects discussed herein may be employed in a sound system having one or more speakers.

Moreover, the ear pad sound system 10 may also comprise an input 14 communicable with the speaker 12. By way of example and not limitation, the input 14 may be a wireless receiver (see FIG. 2A) operative to receive a wireless signal from a wireless transmitter of an audio player 22 (e.g., MP3 player). The wireless receiver 16 may be in communication with the speaker 12 and operative to provide the wireless signal to the speaker 12 such that the speaker may produce audible sounds in accordance with the wireless signal. Alternatively, the input 14 may be a speaker wire 18 (see FIG. 2B). In particular, the left and right speakers 12, b may each be connected to a speaker wire 18. The speaker wires 18 may extend out of the speakers 12 and be joined to each other at a speaker jack 20. The speaker jack 20 may be plugged into the output of the audio player 22 (e.g., Freestyle audio player). The speaker wires 18 carry the audio signal from the audio player 22 to the speaker 12.

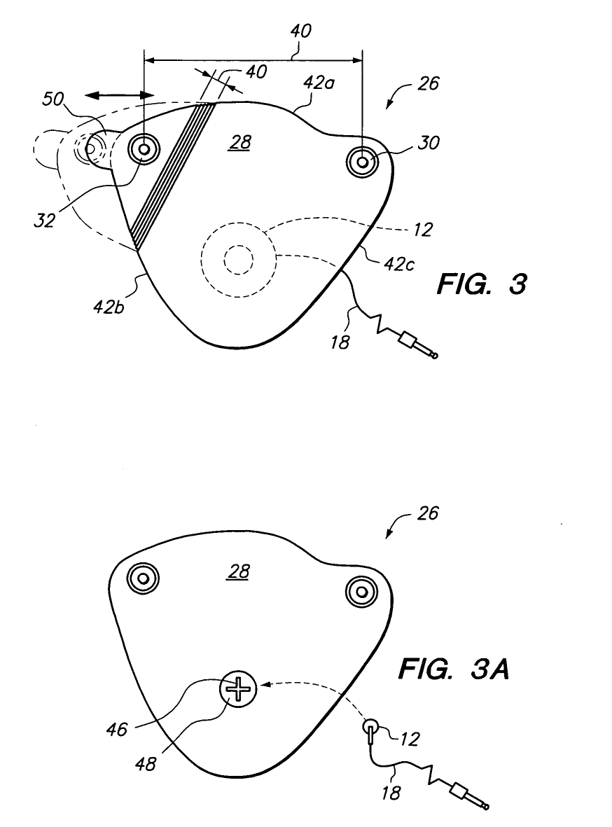

FIG. 3 illustrates an ear pad 26 attachable to a variety of headgears 24 (see FIG. 1). By way of example and not limitation, the headgear 24 may be a snowboard helmet, skateboard helmet, bicycle helmet, etc. Also, the headgear 24 may be an action helmet or watersport helmet which includes but is not limited to skateboard helmet, wakeboarding helmet, kayak helmet, whitewater rafting helmet, etc. The headgear 24 may be worn by a person. The ear pads shown in FIG. 3 may be attached to a variety of headgears such as a bicycle helmet, a snowboard helmet, etc. Moreover, the ear pad 26 may be attached to different sizes of headgear such as a small, medium or large headgear 24. In particular, a body 28 of the ear pad 26 may have a first attachment mechanism 30 attached thereto. Additionally, the body 28 of the ear pad 26 may have a second attachment mechanism 32 attached to the body 28. Similarly, the headgear 24 may have a mating first attachment mechanism 34 and a mating second attachment mechanism 36 attached to the headgear 24. (See FIG. 1). The mating first and second attachment mechanisms 34, 36 may define a distance 38 which varies based upon the size of the headgear 24, type of headgear 24, manufacturer of the headgear 24 as well as other factors. Nonetheless, the first and second attachment mechanism 30, 32 of the ear pad 26 may be mounted to the mating first and second attachment mechanisms 34, 36 of the headgear 24 despite the variations in distance 38 between the mating first and second attachment mechanisms 34, 36 due to the various factors discussed herein and known in the art. The first and second attachment mechanisms 30, 32 of the ear pad 26 may be attached to the mating first and second attachment mechanisms 34, 36 of the headgear 24 because a distance 40 (see FIG. 3) defined by the first and second attachment mechanisms 30, 32 may be adjusted so as to be equal to the distance 38 (see FIG. 1) between the mating first and second attachment mechanisms 34, 36. In particular, at least a portion 44 of the body 28 between the first and second attachment mechanisms 30, 32 may be fabricated from an elastic material. The distance 40 between the first and second attachment mechanisms 30, 32 may be increased or decreased to fit the distance 38 between the mating first and second attachment mechanisms 34, 36 by stretching the elastic portion 44.

The position of the first and second attachment mechanisms 30, 32 and the position of the speaker 12 attached to the body 28 may be sized and configured such that the speaker 12 is optimally adjacent the person's ear when the ear pad 26 is attached to the headgear 24 and worn by the person. Moreover, the speaker 12 may be a directional speaker. The speaker 12 may be attached to the body so as to be directed to the ear of the user.

The ear pad 26 may have a generally triangular configuration, as shown in FIG. 1. the ear pad 26 may define a top edge 42a, a left edge 42b and a right edge 42c. The elastic portion 44 may extend from the top edge 42a to the left edge 42b in a straight manner. Alternatively, the elastic portion 44 may also extend from the top edge 42a to the right edge 42c. It is also contemplated that the entire body 28 may be fabricated from an elastic material or that the elastic portion 44 extend from the top edge 42a to the junction of the left and right edges 42b and c. It is also contemplated that the elastic portion 44 extend partially between the edges 42a,b,c.

The speaker 12 may be attached to the body 28 at a central portion of the body 28. By way of example and not limitation, the speaker 12 may be removably attachable to the body 28, as shown in FIG. 3A. In particular, the body 28 may be fabricated with a cross shaped hole 46 wherein flaps 48 of the cross shaped hole 46 are elastic, flexible and/or resilient. For example, the flaps 48 of the cross shaped hole 46 may be fabricated from rubber. The speaker 12 and the cross shaped hole 46 may be sized and configured such that the speaker 12 may be inserted through the cross shaped hole 46. The speaker wire 18 attached to the speaker 12 may be fed through the cross shaped hole 46 to attach the speaker 12 to the body 28. The speaker 12 may be removed from the body 28 by pulling the speaker 12 and the speaker wire 18 out of the cross shaped hole 46.

Alternatively, it is contemplated that the speakers 12 are permanently attached to the body 28. For example, the body 28 may comprise an interior layer and an exterior layer. The speaker 12 may be disposed between the interior and exterior layers and a periphery of the interior and exterior layers may be attached to each other via a bonding agent, or heat sealing operation. The ear pad 26 may be waterproof by sealing the interior and exterior layers about the entire periphery around the speaker 12. If the input 14 is a speaker wire 18, then the entire periphery of the interior and exterior layers around the speaker 12 may be bonded. The speaker wire 18 may exit the waterproof area and a waterproof glue, adhesive or bonding agent may fill the aperture through which the speaker wire 18 exits out of the waterproof area. Alternatively, if the input 14 is a wireless receiver 16, then the speaker 12 and the wireless receiver 16 may both be disposed between the interior and exterior layers and a periphery of the interior and exterior layers about the speaker 12 and the wireless receiver 16 may be sealed via a bonding agent or heat sealing operation.

The first and second attachment mechanisms 30, 32 and the mating first and second attachment mechanisms 34, 36 are shown in FIGS. 1 and 3 as a snap fastener commonly used in place of buttons to fasten clothing. However, it is also contemplated that the attachment mechanisms 30, 32, 34, 36 may be corresponding hooks and loops (commonly known as Velcro), buttons and button holes and/or other attachment mechanisms known in the art or developed in the future.

The body 28 may be formed with a finger flap 50 (see FIG. 3) to assist in stretching the elastic portion 44. In particular, the second attachment mechanism 32 may be placed sufficiently inward from the edge 42a, b of the body 28 such that the person's fingers may be able to grasp the finger flap 50 and pull the second attachment mechanism 32 apart or further away from the first attachment mechanism 30. Moreover, friction material (e.g., rubber, latex, etc.) may be adhered to the finger flap 50 to aid the user in grasping the finger flap 50. In use, the first attachment mechanism 30 may be attached to the mating first attachment mechanism 34. To attach the second attachment mechanism 32 to the mating second attachment mechanism 36, the person may grasp the finger flap 50 with his/her fingers and pull the second attachment mechanism 32 further away from the first attachment mechanism 30. When the distance 40 between the first and second attachment mechanisms 30, 32 is equal to the distance 38 between the mating first and second attachment mechanisms 34, 36, the user may attach the second attachment mechanism 32 to the mating second attachment mechanism 36.

FIG. 4 illustrates an alternative embodiment for providing an ear pad 26 which may fit a variety of headgears despite the size of the headgear, the manufacturer of the headgear and other factors discussed herein and known in the art. In particular, the body 28 may have a speaker 12 mounted permanently on the body 28 or removeably attached to the body 28, as discussed in relation to FIG. 1. The body 28 may have a first attachment mechanism 30 attached thereto. On an opposed side, a strap 52 may be attached to the body 28 at attachment point 54. By way of example and not limitation, the strap 52 may be attached to the body via hooks and loops (commonly known as Velcro), sewing, rivet, and other means known in the art or developed in the future. A second attachment mechanism 32 may be attached to the strap 52. The strap 52 may have an elastic portion 44 between the attachment point 54 of the strap 52 to the body 28 and the second attachment mechanism 32. Similar to the embodiment shown in FIG. 1, the distance 40 between the first and second attachment mechanism may be increased or decreased by stretching or relaxing the elastic portion 44 of the strap 52 to fit the distance 38 of the mating first and second attachment mechanisms 34, 36 of the head gear 24.

The second attachment mechanism 32 may be positioned sufficiently inward from a distal end of the strap 52 so as to provide for a finger flap 50. Also, friction material may be adhered or formed on the finger flap 50.

In an aspect of the embodiment shown in FIG. 4, the strap 52 may be pivotable about the attachment point 54 (as shown by arrow 55) or fixed (i.e., non pivotable) to the attachment point 54. Additionally, the various aspects discussed in relation to FIG. 3 may be incorporated into the embodiment shown in FIG. 4. By way of example and not limitation, the sound system 10 may be waterproofed. A second elastic portion 44 may be formed in the body 28.

In FIG. 5, the strap 52 may be replaced with a slotted strap 56. The slotted strap 56 may be fixedly attached to the body 28 such that the slotted strap 56 is not pivotable about the attachment point 54. Alternatively, the slotted strap 56 may be attached to the body 28 at the attachment point 54 so as to be pivotable about the body 28, as shown by arrow 55. The attachment of the slotted strap 56 to the body 28 may be made by a rivet, rotatable coupling or other methods known in the art or developed in the future. The second attachment mechanism 32 may be slidingly fixed to the slotted strap 56. By way of example and not limitation, the slotted strap 56 may be fabricated from a hard plastic material. The slotted strap 56 may have a slot 58 extending longitudinally. The second attachment mechanism 32 may comprise a post 57 (see FIG. 5A) which may be disposed through the slot 58 of the slotted strap 56. A nut 59 may be threaded onto the post 57 to tighten and fix the second attachment mechanism 32 to a particular position on the slotted strap 56.

In use, the first attachment mechanism 30 may be attached to the mating first attachment mechanism 34 of the headgear. The second attachment mechanism 32 may be loosened to be longitudinally slidable along the slot 58 of the slotted strap 56. The second attachment mechanism 32 is slid along the slot 58 until the distance 40 between the first and second attachment mechanisms 30, 32 is matched to the distance 38 between the mating first and second attachment mechanisms 34, 36. The position of the second attachment mechanism 32 on the slotted strap 56 is fixed by tightening the nut 59 of the second attachment mechanism 32. The second attachment mechanism 32 is then attached to the mating second attachment mechanism 36. Alternatively, the second attachment mechanism 32 may be attached to the mating second attachment mechanism 36 then the nut 59 may be tightened to fix the second attachment mechanism 32 to the slotted strap 56.

It is contemplated that the various aspects discussed in relation to FIG. 3 may be employed in the embodiment shown in FIG. 5. By way of example and not limitation, the sound system 10 may be waterproofed. The sound system 10 may be removeably attachable to the body or permanently attached to the body.

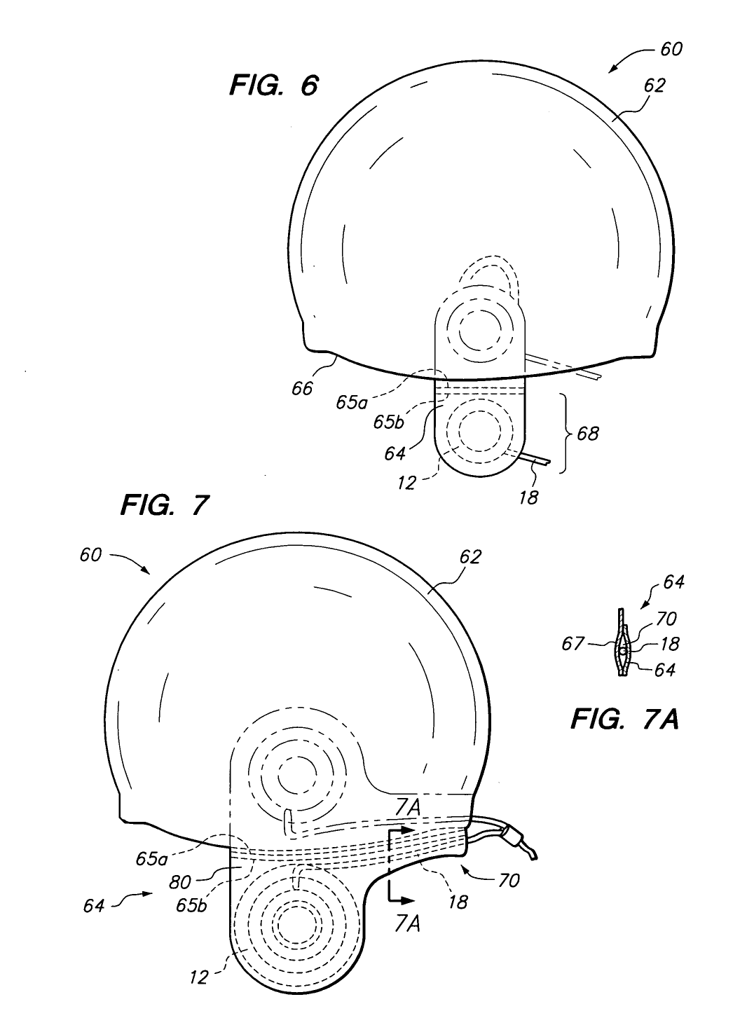

FIG. 6 illustrates a swim cap 60 for listening to audio sounds while swimming. The swim cap 60 shown in FIG. 6 is a left side view. The swim cap 60 has a stretchable head engaging portion 62 and a flap extension 64. The stretchable head engaging portion 62 may be similar to a typical swim cap. The stretchable head engaging portion 62 may be placed over a person's head so as to cover the person's ears and hair. A lower periphery 66 of the stretchable head engaging portion 62 may be positioned about the forehead of the wearer, under the left and right ears of the wearer and adjacent a lower back portion of the person's head.

The flap extension 64 and the stretchable head engaging portion 62 may be fabricated from a unitary material. In particular, two halves of the stretchable head engaging portion 62 and the flap extension 64 may be die cut in the shape shown in FIG. 6 from a sheet of silicone, latex, lycra material or other suitable material. The two halves may then be sealed together at the upper periphery. The flap extension 64 is foldable under the stretchable head engaging portion 62. A single or plurality of score line 65 a,b such as an indentation or a partial slit cut which does not penetrate the entire depth of the sheet material may be made between the stretchable head engaging portion 62 and the flap extension 64.

A waterproof enclosure 68 may be formed on the flap extension 64. The waterproof enclosure 68 may house a speaker 12 such that the wearer may listen to audio sounds (e.g., music, instructor's voice, etc) while the wearer is swimming.

The waterproofed enclosure 68 may be formed with an upper water impermeable layer and a lower water impermeable layer. The water impermeable layer may be a sheet of latex, rubber, etc. The speaker 12 may be disposed between the upper and lower water impermeable layers. The upper and lower water impermeable layers may sealed to each other in a water impermeable manner about the periphery of the speaker 12. If the speaker is attached to a wireless receiver, then the entire speaker 12 and wireless receiver 16 may be disposed between the upper and lower water impermeable layers and sealed therein so as to form the waterproof enclosure 68. The waterproof enclosure 68 may then be glued, sewn or otherwise fixedly attached to the flap extension 64.

Alternatively, the waterproof enclosure 68 may be formed by the flap extension 64 and a water impermeable layer. In this embodiment, the flap extension 64 is fabricated from a water impermeable material or is coated so as to be water impermeable. The speaker 12 is disposed between the flap extension 64 and the water impermeable layer which are sealed about the circumference of the speaker 12. If the input 14 is a wireless receiver, then the speaker and wireless receiver are both encapsulated between the flap extension 64 and the water impermeable layer. If the input 14 is a speaker wire 18, then the speaker 12 is encapsulated between the flap extension 64 and the water impermeable layer or the upper and lower exterior layers. The speaker wire 18 protrudes out of the waterproof enclosure 68. To insure that water does not enter the waterproof enclosure 68 through the aperture through which the speaker wire 18 protrudes out of the waterproof enclosure 68, a waterproof bonding agent (e.g., glue, adhesive, etc.) may be placed within such aperture and about the speaker wire 18.

In use, the wearer may place the stretchable head engaging portion 62 over the wearer's head. Once the stretchable head engagement portion 62 is properly fitted on the person's head, left and right sides of the lower periphery 66 is lifted and the flap extension 64 is folded inward under the stretchable head engagement portion 62. In this manner, the speaker 12 in the waterproof enclosure 68 formed on the flap extension 64 is disposed immediately adjacent the wearer's ears such that the wearer may listen to audio sounds while swimming.

The position of the speaker to the wearer's head may be adjusted by folding the flap extension 64 under the stretchable head engaging portion 62 at various positions about the vertical location of the flap extension 64. By way of example and not limitation, to lower the position of the speaker 12, the flap extension 64 may be folded at line 65b shown in FIG. 4, rather than folding the flap extension 64 at the lower periphery 66 or fold line 65 a.

The speaker's position is held in place adjacent to the swimmer's ear by the compression force of the swim cap against the speaker 12 and the swimmer's head. Additionally, the speaker's position is held in place by the attachment of the flap extension 64 to the head engaging portion 62. These two forces securely holds the speaker 12 in position while the swimmer swims or moves vigorously in water such that the speaker 12 does not shift during use.

In relation to FIG. 7, the swim cap 60 may have the same structure as that discussed in relation to FIG. 6. However, the swim cap 60 shown in FIG. 7 may also have a guide 70 for the speaker wire 18. In particular, the flap extension 64 may extend from sides of the head engaging portion 62 to the rear. The speaker 12 may be disposed on an inner side of the flap extension 64 and the speaker wire 18 may be disposed on the inner side of the flap extension 64 toward the rear. An interior layer 67 (see FIG. 7A) may be placed over the speaker wire 18 on the inner side of the flap extension 64 and sealed to the enlarged flap extension 64 to form the guide 70 (see FIG. 7A) which routes the speaker wire 18 to the lower back portion of the person's head.

Alternatively, instead of forming the guide 70 to route speaker wire 18 to the back of the person's head, the speaker wire 18 may be disposed between the flap extension 64 and the head engaging portion 62, when the flap extension 64 is folded under the stretchable head engaging portion 62. The speaker wire 18 may then protrude out of the rear portion of the swim cap 60 via an aperture. In this manner, the flap extension 64 and the stretchable head engaging portion 62 form the guide 70 such that the wire is routed to the rear of the person's head.

To aid in folding the flap extension 64 under the stretchable head engaging portion 62, the layer of the flap extension 64 and the stretchable head engaging portion 62 may be scored (i.e., lined indentation) or a slit cut may be made at the lower periphery 66 and a plurality of other locations (e.g., 65a, b).

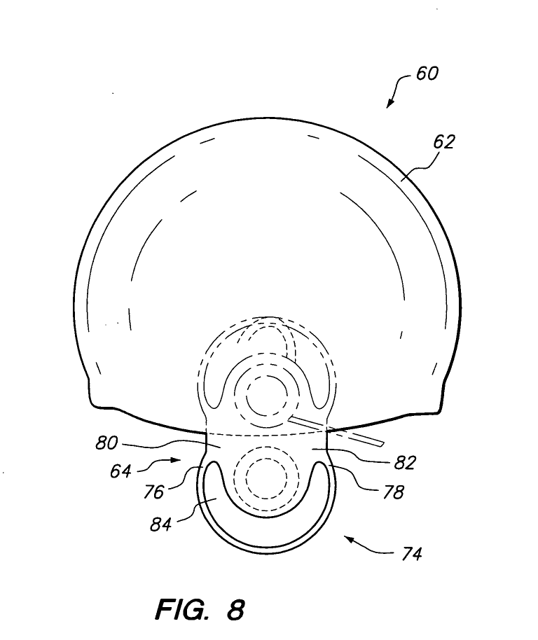

The swim cap 60 shown in FIG. 8 illustrates a further refinement of the swim cap 60 shown in FIG. 6. The flap extension 64 may have an ear holder 74. The ear holder 74 may be attached to each of the flap extensions 64 on the left and right sides of the person's head. The ear holder 74 may have a C-shaped configuration. A first distal end 76 of the ear holder 74 may be attached to a forward portion 80 of the flap extension 64. A second distal end 78 of the ear holder 74 may be attached to the rearward portion 82 of the flap extension 64. A gap 84 may be formed between the flap extension 64 and the ear holder 74 for receiving the ear.

In use, the wearer places the stretchable head engaging portion 62 over the person's head. The left and right sides of the stretchable head engaging portion 62 are slightly lifted and the flap extensions 64 tuck under the stretchable head engaging portion 62. The ear holder 74 is looped over the ear of the person. While the swimmer is swimming, the ear holder 74 prevents the speaker 12 embedded into the flap extension 64 from shifting downward such that optimal positioning of the speaker 12 adjacent to the swimmer's ear is maintained even though the person is vigorously swimming.

The ear holder 74, flap extension 64 and the stretchable head engaging portion 62 may be fabricated from a unitary material such as silicone, latex, lycra, etc. Additionally, the ear holder 74 may be incorporated into the swim cap shown in FIG. 7. To incorporate the ear holder 74 into the swim cap shown in FIG. 7, the first distal end 76 of the ear holder 74 may be attached to the forward portion 80 of the flap extension 64. The second distal end 78 of the ear holder 74 may be attached to the flap extension 64 between the guide 70 and the speaker 12.

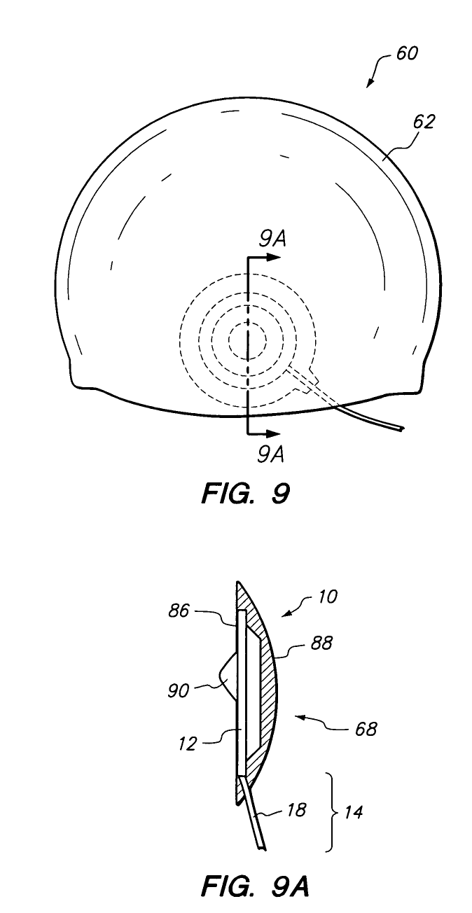

FIGS. 9 and 9A illustrate a sound system 10 which may be used with any swim cap. In particular, the sound system 10 (see FIG. 9A) comprises a speaker 12 that is removably disposable under the stretchable head engaging portion 62 on top of the ear of the wearer. The speaker 12 of the sound system is held in place next to the wearer's ears by compression of the stretchable head engaging portion 62 against a wearer's head and the sound system 10.

The sound system 10 may comprise a speaker 12 and an input 14. The input 14 may be a wireless receiver or a speaker wire 18. In the event that the input is a wireless receiver 16, then the speaker and the entire wireless receiver may be encapsulated within a waterproof enclosure 68. The waterproof enclosure 68 may define a head engaging surface 86 and an exterior surface 88. The head engaging surface 86 may be generally flat and have a protrusion 90 aligned to a center of the speaker 12 encapsulated within the waterproof enclosure 68. The protrusion 90 may be sized and configured to be received into the wearer's ears. In use, the protrusion 90 aids the wearer in locating the speaker 12 to the wearer's ear such that the speaker 12 is aligned to the wearer's ear. In particular, the protrusion 90 is disposed within the wearer's ear and the speaker 12 is automatically aligned to the wearer's ear.

The exterior surface 88 may have a curved configuration for receiving the head engaging portion 62. Moreover, the exterior surface 88 may have friction material adhered or otherwise disposed on the exterior surface 88. The friction material frictionally engages the interior surface of the head engaging portion 62 to mitigate against shifting of the waterproof pouch 68 during use. The exterior surface 88 may also sufficiently protrude away from the wearer's head such that the head engaging portion 62 contacts the waterproof pouch 68 and compresses the waterproof pouch 68 against the wearer's head.

The head engaging surface 86 of the waterproof enclosure 68 may be fabricated from a soft pliable material such that the head engaging surface 86 does not cause discomfort to the wearer. Alternatively, a soft pliable layer may be adhered to the head engaging surface 86 such that the sound system does not cause discomfort to the wearer.

In the event that the input 14 is a speaker wire 18, the speaker 12 may be encapsulated within the waterproof enclosure 68 by sealing the head engaging surface 86 and the exterior surface 88 about the periphery of the speaker 12. The speaker wire 18 protrudes out between the head engaging surface 86 and the exterior surface 88. A waterproof bonding agent may be applied around the wire 18 to insure that water or other liquid does not enter the waterproof enclosure 68 via the aperture provided for the speaker wire 18.

The protrusion 90 subject matter discussed in relation to FIGS. 9 and 9A may be incorporated into the other swim caps discussed herein.

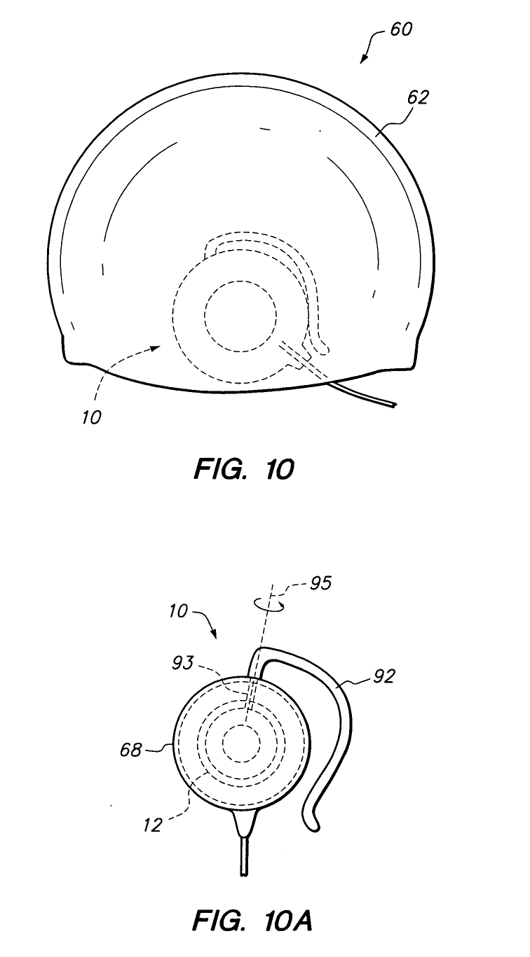

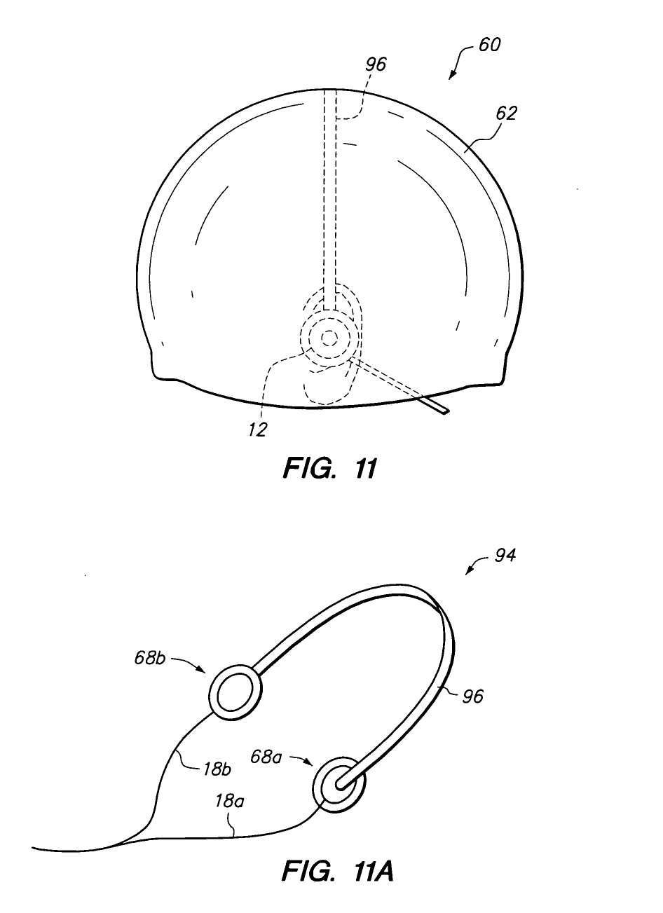

FIGS. 10 and 10A illustrates an alternative embodiment to the sound system 10 shown in FIG. 9. In particular, the sound system 10 may have the same configuration as that shown in FIG. 9. It is contemplated that the sound system 10 may or may not have the protrusion 90. Moreover, the waterproof enclosure 68 may have an ear hook 92. The ear hook 92 may be rigidly or pivotably connected in an axis as aligned to a base stem 93. The ear hook 92 may have a J-shaped configuration so as to hook over the ear of the wearer. The ear hook 92 may be fabricated from a flexible material and/or a pliable material. In this embodiment, the sound system 10 may be held adjacent to the wearer's ear by the ear hook 92 as well as the compression of the sound system 10 against the wearer's ears by the stretchable head engaging portion 62.

The ear hook 92 may generally be in the same plane as the sound system 10. Moreover, the ear hook 92 may be attached to sound system in the following manner. The waterproof pouch 68 may have a water impermeable upper layer and a water impermeable lower layer. The speaker 12 may be disposed between the water impermeable upper and lower layers. The base stem 93 of the ear hook 92 may also be disposed between the water impermeable upper and lower layers. The upper and lower layers may be sealed to each other about the periphery of the speaker 12. The base stem 93 may be attached between the upper and lower layers via a waterproof bonding agent. The ear hook 92 may be fabricated from a sufficiently malleable material such that the wearer can bend and shape the ear hook 92 to fit his/her ears. In use, the ear hook 92 is shaped to fit up and around the user's ear between the soft part of the user's ear and the user's head. The waterproof bonding agent used to attach the base stem 93 to the upper and lower layers may be sufficiently strong to withstand any stresses caused by the swimmer adjusting the ear hook 92. In use, the swimmer may slip the ear hook 92 over his/her ears. Thereafter, the head engaging portion 62 may be worn by the swimmer compressing the sound system 10 against the swimmer's head.

In conjunction with the sound system 10 discussed in relation to FIG. 10, the protrusion 90 discussed in relation to FIG. 9 may be incorporated into sound system 10 discussed in relation to FIG. 10. Additionally, the guide 70 discussed in relation to FIG. 7 may be incorporated into the swim cap used in conjunction with the sound system 10 discussed in relation to FIGS. 9 and 10.

FIGS. 11 and 11A illustrate a headset 94 with a waterproof sound system. The headset 94 may have a flexible bendable head support frame 96. Left and right waterproof enclosures 68 a,b may be attached to opposed distal ends of the frame 96. Each of the waterproof enclosure 68 may house a speaker 12. The wearer may wear the headset 94 in a typical fashion as shown in FIG. 11. In particular, the speakers 12 are positioned adjacent the swimmer's ears. The waterproof enclosures 68 may be similar to the waterproof pouch 68 shown in FIG. 9. In this instance, the waterproof enclosures 68 are disposed adjacent to the exterior of the swimmer's ears. Alternatively, the waterproof enclosures 68 may be similar to waterproof ear buds. In this instance, the ear buds may be placed within the swimmer's ears. The stretchable head engaging portion 62 may be placed over the wearer's head so as to cover the waterproof enclosures 68 formed on opposed distal ends of the frame 96. The input 14 may be speaker wires 18 a,b. In this instance, the speaker wires 18 may be routed to the rear of the person's head by tucking the speaker wires 18 under the head engaging portion 62. Alternatively, the swim cap may be formed with the guides 70 shown and discussed in relation to FIG. 7. The input may alternatively be a wireless receiver. In this instance, the guide 70 is not formed in the stretchable head engaging portion 62.

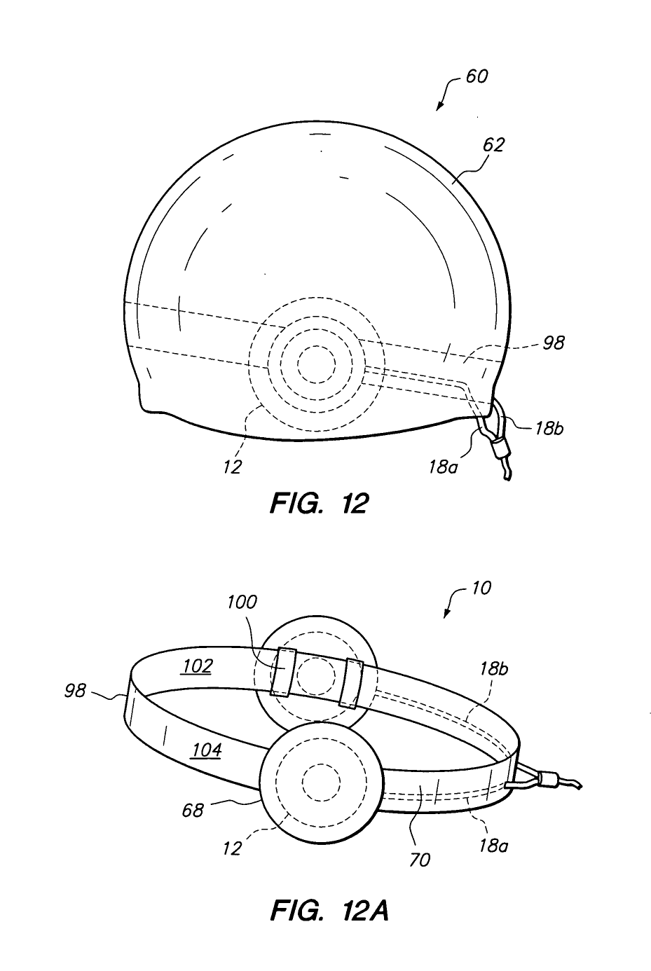

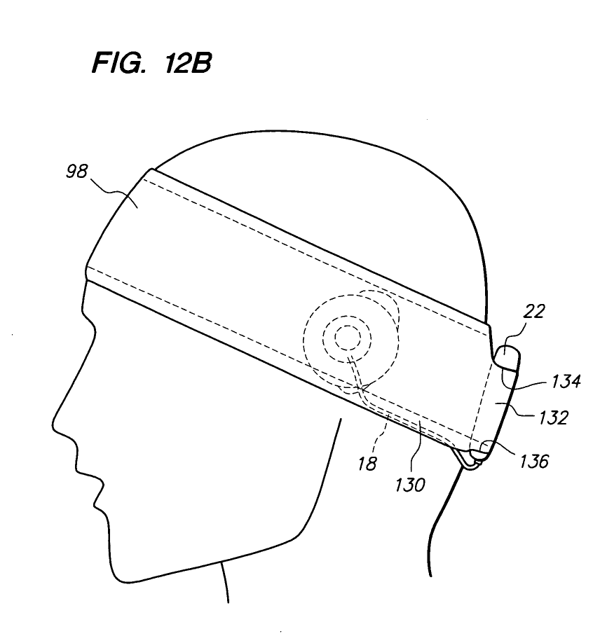

FIGS. 12, 12A and 12B illustrate an alternate embodiment of a sound system 10 that may be utilized with any swim cap 60. In particular, the sound system may comprise a speaker 12 enclosed within a waterproof enclosure 68. The waterproof enclosure 68 may be attached to the inner side 102 of an elastic band 98 or an outer side 104 (see FIG. 12A) of the elastic band 98. The waterproof enclosure 68 shown in FIG. 12A is shown as being attached to the outer side of the elastic band 98. To use the sound system 10, the wearer may place the elastic band 98 about the wearer's head. The left and right speakers 12 may be positioned adjacent to the wearer's left and right ears. The speaker wires 18a, b may be routed to the rear side of the wearer's head. After the band 98 and the sound system 10 are in place adjacent to the wearer's ears, the swim cap 60 may be worn over the band 98 and speakers 12, as shown in FIG. 12. The sound system 10 is held in place by the elastic band 98 and the head engaging portion 62 compressing against the sound system 10.

As a further refinement, the waterproof enclosures 68 may be formed with one or more loops 100 that extends from an upper portion of the waterproofed enclosure 68 to a lower portion of the waterproof enclosure 68. The band 98 may be fed through the loop 100 such that the waterproof enclosure 68 may slide along the band 98 to adjust the position of the left and right speakers adjacent to the wearer's left and right ears. In this manner, depending on the size of the person's head and other ratios of the person's head, the speakers 12 may be slid along the elastic band 98 to properly adjusted the speakers 12 to be positioned optimally adjacent the person's ears for optimal listening of the audible sounds emanating from the speaker 12.

The input 14 of the sound system 10 may be a wireless receiver. In this instance, the waterproofed enclosure 68 encapsulates both the speaker 12 and the wireless receiver 16. Alternatively, the input 14 may be a speaker wire 18, as shown in FIGS. 12 and 12A. In this instance, the speaker wire 18 may be routed to the rear of the person's head by embedding the speaker wires 18 into the elastic band 98 as shown in FIG. 12A. In particular, the elastic band 98 may be fabricated from an interior layer and an exterior layer. The interior and exterior layers may be fabricated from an elastic material. The speaker wires 18 may be fed through the elastic band 98 between the interior and exterior layers. The upper and lower edges of the interior and exterior layers may be sewn or otherwise attached to form the guide 70 for the speaker wire 18. The speaker wire 18 may exit out of the elastic band 98 from the rear of the elastic band 98 via one or more apertures. Alternatively, as shown in FIG. 12B, the speaker wires 18 may be routed to the rear of the person's head by embedding the speaker wires 18 into the hem 130 of the elastic band 98.

FIG. 12B illustrates an audio player pouch 132 integrated into the elastic band 98. The rear portion of the elastic band 98 may be formed with the audio player pouch 132 sized and configured to receive an audio player 22 in an upright, upside down, sideway or other orientation. The pouch 132 may be fabricated from an elastic material so as to conform to a variety of different sized audio players 22. The pouch 132 may have an upper open end 134 which needs to be stretched opened to insert the audio player 22 into the pouch 132. The upper open end 134 may close up to secure the audio player 22 in the pouch 132. Alternatively, the upper open end 134 may circumscribe the outer periphery of the audio player 22 as shown in FIG. 12B. The pouch 132 may also have an open lower end 136 which has an aperture sufficiently large to allow the speaker wires 18, if any, to proceed therethrough and be routed to the speakers 12 but small enough such that the audio player 22 does not fall therethrough. Alternatively, the audio player 22 may be held in the pouch 132 by frictional engagement between the exterior surface of the audio player 22 and the interior surface of the pouch 132. The pouch 132 may be fabricated by stitching or otherwise attaching a flexible and/or elastic layer to the rear portion of the band 98 at the left and right edges of the layer and partially at the upper and lower edges to form the upper and lower open ends 134, 136.

This embodiment of the sound system 10 may be especially beneficial to female swimmers to manage their hair. In particular, the elastic band 98 may behave as a standard headband worn by females to keep the hair behind and out of the face. Accordingly, the female wearer may wear the elastic band 98 to keep the female wearer's hair directed rearward and out of her face. After the elastic band 98 is properly positioned, the speakers 12 may be positioned adjacent the wearer's ears. The swim cap 60 may then be placed over the elastic band 98 and the speakers 12. In this embodiment, the speakers 12 are held in place by the elastic band 98 and the compression force of the stretchable head engaging portion 62 on the speakers 12.

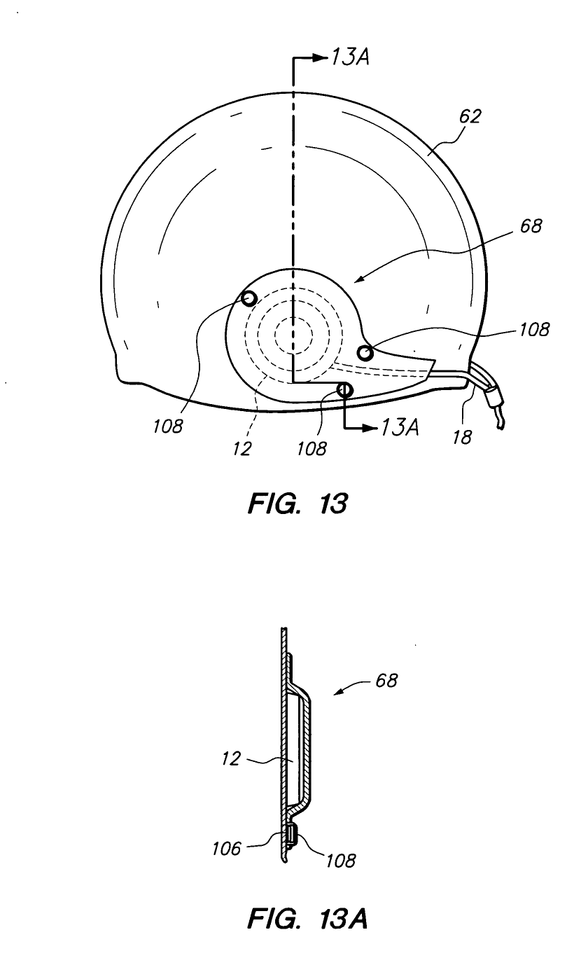

FIGS. 13 and 13A illustrate a waterproof enclosure 68 that is removably attachable to the stretchable head engaging portion 62. By way of example and not limitation, the waterproof enclosure 68 may house a speaker 12. Audio signals may be provided to the speaker 12 via an input 14 which may be a wireless receiver 16 or a speaker wire 18. The waterproof enclosure 68 may be fabricated with a lower water impermeable layer and an upper water impermeable layer. The speaker 12 may be disposed therebetween and an outer periphery of the lower and upper waterproof impermeable layers may be sealed together to encapsulate the speaker 12 therebetween in a waterproof manner. If the input 14 is a wireless receiver, then the wireless receiver 16 and the speaker 12 may be encapsulated between the upper and lower water impermeable layers to provide the waterproofed enclosure 68. If the input 14 is a speaker wire 18, then the speaker wire 18 may be routed toward the rear of the swim cap 60. The aperture through which the speaker wire 18 is fed out of the waterproof enclosure 68 between the upper and lower waterproof impermeable layers may be filled with a waterproof bonding agent.

The waterproof enclosure 68 may be removably attachable to the stretchable head engaging portion 62 via hooks and loops (commonly known as Velcro), snaps (as shown), or buttons and button holes, etc. By way of example and not limitation, the exterior surface of the head engaging portion 62 may be formed with snaps 106. The waterproof enclosure 68 may be formed with mating snaps 108 which engage the snaps 106 of the head engaging portion 62. To mount the waterproof enclosure 68 to the head engaging portion 62, the snaps 106 and mating snaps 108 are engaged to each other. To remove the waterproof enclosure 68 from the head engaging portion 62, the snaps 106, 108 are disengaged from each other. The snaps 106 may be formed on the exterior surface of the head engaging portion 62 or on the interior surface of the head engaging portion 62. Alternatively, buttons may be formed on the exterior surface of the head engaging portion 62. The waterproofed enclosure 68 may be formed with slotted button holes to receive the buttons such that the waterproofed enclosure 68 may be attached to the head engaging portion via the buttons and slotted button holes. The buttons may be formed or attached to the exterior surface of the head engaging portion 62 or the interior surface of the head engaging portion 62.

It is also contemplated that the sound system 10 shown in relation to FIGS. 4-10 may be removeably attachable to the swim cap as discussed in relation to FIG. 13. By way of example and not limitation, in the swim cap shown in FIGS. 6-8, the interior surface of the swim cap and the flap extensions 64 may be formed with mating attachment mechanisms (e.g., snap fasteners, hooks and loops, etc.). When the flap extension 64 is tucked under the head engaging portion 62, the mating attachment mechanisms are engaged to each other. In this manner, the flap extensions 64 will not come out from under the head engaging portion 62. Additionally, the mating attachment mechanisms may be used to adjust the speaker position to the swimmer's ears. In particular, the interior surface of the head engaging portion 64 may have a plurality of attachment mechanisms. Each of the attachment mechanisms may define a different speaker position. The user may attach the attachment mechanism of the flap extension 64 to the appropriate attachment mechanism on the interior surface of the head engaging portion.

Moreover, the sound system 10 shown in FIG. 9 may be removeably attachable to the head engaging portion via mating attachment mechanisms. For example, the exterior surface 88 of the waterproof pouch 68 may have hooks. The interior surface of the head engaging portion may be lined with loops. The swimmer may first wear the head engaging portion 62. Thereafter, the swimmer may lift the left and right sides of the head engaging portion and position the sound system adjacent to the swimmer's ears. Once the left and right sides of the head engaging portion 62 are released, the loops lined on the interior surface of the head engaging portion 62 engages the hooks attached to the exterior surface 88 of the waterproof enclosure 68. The swimmer may now remove the head engaging portion 62 and re-wear the head engaging portion 62 without having to adjust the position of the sound system 10 to the swimmer's ears.

The swim cap 60 and other embodiments of the swim cap discussed herein have other various applications other than allowing the swimmer to listen to his/her music while swimming. By way of example and not limitation, the swim cap 60 may be fabricated with a speaker 12 and a wireless receiver 16. A base station may transmit audio sounds (e.g., music, voice commands, etc.) to the wireless receiver such that the swimmer may listen to such audio sounds. For example in synchronized swimming, an instructor may transmit voice commands to a plurality of sounds systems worn by the team via wireless receivers such that the plurality of swimmers may hear the instructor's voice commands whether the swimmer is above water or submersed entirely under water.

The various aspects of the sound system 10 discussed in relation to FIGS. 6-13 may be employed in a beanie, hat, hat with ear muffs or other head gear such as an action helmet, watersport helmet including but not limited to skateboarding helmet, kayak helmet, whitewater rafting helmet, etc. By way of example and not limitation, a beanie may be formed with flap extensions which house a speaker. The flap extensions may be folded under and within the beanie such that the speaker is aligned to the wearer's ears. Also, a hat may be formed with ear muffs. The ear muffs may be formed with a housing for receiving a speaker. The ear muffs may extend from an inner periphery of the hat. The speakers may be aligned to the wearer's ears when the ear muffs are hanging downward. The wearer may tuck the ear muffs/speakers within the hat to store the sound system when not in use.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An ear pad sound system attachable to a variety of headgears, the ear pad sound system comprising:
a body sized and configured to receive an ear of a person, the body defining a first mounting area and a second mounting area, at least a portion of the body between the first mounting area and the second mounting area being fabricated from an elastic material,
a first attachment mechanism attached to the first mounting area of the body and attachable to the mating first mounting area of a selected head gear;
a second attachment mechanism attached to the second mounting area of the body, the first and second attachment mechanisms being simultaneously attachable to the mating first and second attachment mechanisms of the variety of headgears by stretching the elastic portion until the distance between the first and second mounting areas is equal to the distance between the mating first and second mounting areas of the selected head gear;
a sound system having an input for receiving audio signals and a speaker attached to the input and in communication therewith for translating the received signals to audible sounds, the sound system being attached to the body so as to be positionable adjacent to the ear of the person.

2. The ear pad sound system of claim 1 wherein the selected head gear is a headband, biker helmet, beanie, swim cap, snowboard helmet, baseball helmet, action helmet or watersport helmet.

3. The ear pad sound system of claim 1 wherein the body further comprises a finger flap for grasping and stretching the elastic portion.

4. The ear pad sound system of claim 1 wherein friction material is attached to the finger flap.

5. An ear pad sound system attachable to a variety of headgears, the ear pad sound system comprising:
a body sized and configured to receive an ear of a person, the body defining a first mounting area and a headgear mounting area;
a strap defining a mating headgear mounting area attached to the headgear mounting area of the body and a second mounting area, at least a portion of the strap between the second mounting area and the mating headgear mounting area being fabricated from an elastic material,
a first attachment mechanism attached to the first mounting area of the body and attachable to a mating first mounting area of a selected head gear;
a second attachment mechanism attached to the second mounting area of the strap, the first and second attachment mechanisms being simultaneously attachable to mating first and second mounting areas of the variety of headgears by stretching the elastic portion of the strap until the distance between the first and second attachment mechanisms is equal to the distance between the mating first and second mounting areas of the selected head gear;
a sound system having an input for receiving audio signals and a speaker attached to the input and in communication therewith for translating the received signals to audible sounds, the sound system being attached to the body so as to be positionable adjacent to the ear of the person.

6. The ear pad sound system of claim 5 wherein the selected head gear is a headband, biker helmet, beanie, swim cap, snowboard helmet, baseball helmet, action helmet or watersport helmet.

7. The ear pad sound system of claim 5 wherein the strap further comprises a finger flap for grasping and stretching the elastic portion.

8. The ear pad sound system of claim 5 wherein the strap is pivotally mounted to the body.

9. An ear pad sound system attachable to a variety of headgears, the ear pad sound system comprising:
a body sized and configured to receive an ear of a person, the body defining a first mounting area and a strap mounting area;
a strap defining a mating strap mounting area attached to the strap mounting area of the body and a distal area, the strap having a slot between the strap mounting area and the distal area;
a first attachment mechanism attached to the first mounting area of the body and attachable to a mating first mounting area of a selected headgear;
a second attachment mechanism slideably attached to the slot of the strap and attachable to a mating second mounting area of the selected headgear, the first and second attachment mechanisms being simultaneously attachable to the mating first and second attachment mechanisms by sliding the second attachment mechanism along the slot until a distance between the first and second attachment mechanisms is equal to a distance between the mating first and second mounting areas of the selected head gear and locking the second attachment mechanism to the slotted strap;
a sound system having an input for receiving audio signals and a speaker attached to the input and in communication therewith for translating the received signals to audible sounds, the sound system being attached to the body and positioned adjacent to the ear of the person.

10. The ear pad sound system of claim 9 wherein the selected head gear is a headband, biker helmet, beanie, swim cap, snowboard helmet, baseball helmet, or watersport helmet.

11. The system of claim 9 wherein the slotted strap is pivotable about the body.

12. A head gear for listening to audio sounds while participating in an activity, the head gear comprising:
a head engaging portion for covering a person's head when worn by the person, the head engaging portion defining a lower periphery;
a sound system comprising a speaker and an input in communication with the speaker;
a flap extension extending away from the head engaging portion at the lower periphery, the flap extension being foldable about the lower periphery of the head engaging portion;
wherein the sound system is attached to the flap extension and the speaker is waterproof.

13. The head gear of claim 12 wherein the head engaging portion is a headband, beanie, or swim cap.

14. The head gear of claim 12 wherein the head engaging portion is stretchable.

15. The head gear of claim 12 wherein the flap extension has a waterproof pouch and the speaker is disposed in the waterproof pouch for waterproofing the speaker.

16. The head gear of claim 12 wherein the speaker is waterproof.

17. The head gear of claim 12 wherein the flap extension is inwardly foldable into the head engaging portion to further aid in keeping the sound system dry when the head gear is in use.

18. The head gear of claim 12 wherein the flap extention is removeably attachable to an interior surface of the head engaging portion.

19. The head gear of claim 12 wherein the flap extension is outwardly foldable and attachable to an exterior surface of the head engaging portion.

20. The head gear of claim 12 wherein the input is a speaker wire and the speaker wire extends out of the pouch of the flap extension.

21. The head gear of claim 20 wherein the flap extension extends from sides of the head engaging portion to a rear of the head engaging portion, the speaker wire being attached to the flap extension and routed from the pouch to the rear of the head engaging portion.

22. The head gear of claim 21 wherein the speaker wire is embedded between two layers of material.

23. The head gear of claim 21 wherein the speaker wire is disposed between the flap extension and the head engaging portion when the flap extension is folded inward into the head engaging portion, the speaker wire extends out of a speaker aperture formed adjacent the rear of the head engaging portion.

24. The head gear of claim 12 further comprising an ear holder attached to the flap extension for hooking over a person's ear to prevent the speaker from shifting away from the person's ear while the person participates vigorously in the activity.

25. The head gear of claim 25 wherein the ear holder defines first and second distal ends which are respectively attached to forward and rearward portions of the flap extensions.

26. The head gear of claim 24 wherein the ear holder and the head engaging portion are fabricated from a unitary material.

27. The head gear of claim 24 wherein the ear holder is fabricated from a flexible material, rubber, silicone or latex.

28. A head gear for listening to audio sounds while participating in an activity, the head gear comprising:
a sound system comprising a speaker and an input communicable with the speaker;
a waterproof pouch sized and configured to receive the sound system, the waterproof pouch defining a head engaging surface, the head engaging surface being fabricated from a soft, pliable material such that a person's ear does not feel uncomfortable when the head gear is worn by the person;
a stretchable head engaging portion for compressing onto a person's head when worn by the person, the stretchable head engaging portion sized and configured to cover the waterproof pouch when disposed adjacent to the person's head to hold the speaker in place adjacent to the person's ear.

29. The head gear of claim 28 wherein the head engaging portion is a headband, beanie, or swim cap.

30. The head gear of claim 28 wherein the head engaging surface is defined by a soft flexible layer attached to an inner side of the waterproof pouch.

31. The head gear of claim 28 wherein the head engaging surface comprises a protrusion sized and configured for insertion into the person's ear for positioning the speaker adjacent to the person's ear.

32. The head gear of claim 28 further comprising an attachment mechanism attached to an exterior surface of the waterproof pouch and a mating attachment mechanism attached to an interior surface of the head engaging portion.

33. The head gear of claim 28 further comprising an attachment mechanism attached to an interior surface of the waterproof pouch and a mating attachment mechanism attached to an exterior surface of the head engaging portion.

34. The head gear of claim 32 wherein the attachment mechanism and mating attachment mechanism are respectively hooks and loops.

35. The head gear of claim 28 further comprising an ear holder attached to the waterproof pouch for hooking over the person's ear to prevent the waterproof pouch from shifting while the person is participating in the activity.

36. The head gear of claim 35 wherein the ear holder has a J shaped configuration.

37. The head gear of claim 35 wherein the ear holder has a C shaped configuration.

38. A head gear for listening to audio sounds while participating in an activity, the head gear comprising:
a stretchable head engaging portion for compressing onto a person's head when worn by the person, the stretchable head engaging portion defining ear areas;
at least one mounting device attached to the ear areas of the stretchable head engaging portion;
a sound system comprising a speaker and an input communicable with the speaker;
a waterproof pouch sized and configured to receive the sound system for preventing water from contacting the speaker;
at least one corresponding mounting device attached to the waterproof pouch for mounting the pouch to the stretchable head engaging portion.

39. The head gear of claim 38 wherein the head engaging portion is a headband, swim cap, or beanie.

40. The head gear of claim 38 wherein the mounting device is a snap fastener, hooks and loops or buttons/button holes.

41. The head gear of claim 38 wherein the mounting device is attached to an interior of the head engaging portion.

42. The head gear of claim 38 wherein the mounting device is attached to an exterior of the head engaging portion.

43. The head gear of claim 38 wherein the input is a speaker wire or a wireless receiver.

44. A head gear for listening to audio sounds while participating in an activity, the head gear comprising:
an elastic band wearable about a circumference of a person's head;
a sound system having a speaker and an input communicable with the speaker;
a waterproof pouch for receiving the sound system, the waterproof pouch attached to the elastic band;
a stretchable head engaging portion for compressing onto a person's head when worn by the person, the stretchable head engaging portion sized and configured to cover the elastic band when worn about the circumference of the person's head, the stretchable head engaging portion pressing on the elastic band and the waterproof pouch to maintain a position of the waterproof pouch adjacent an ear of the person.

45. The head gear of claim 44 wherein the head engaging portion is a swim cap or beanie.

46. The head gear of claim 44 wherein the waterproof pouch is fixedly attached to the elastic band.

47. The head gear of claim 44 wherein the waterproof pouch has a loop for slidingly receiving the elastic band to adjust a position of the speaker to the person's ear.

48. A head gear for listening to audio sounds while participating in an activity, the head gear comprising:
left and right speakers operative to produce an audible sound;
at least one input communicable with the left and right speakers;
a left waterproof pouch sized and configured to receive the left speaker;
a right waterproof pouch sized and configured to receive the right speaker;
a flexible bendable frame sized and configured to wrap around a top portion of the person's head, the frame defining a left distal end portion attached to the left waterproof pouch and a right distal end portion attached to the right waterproof pouch;
a stretchable head engaging portion for compressing onto a person's head when worn by the person, the stretchable head engaging portion sized and configured to cover the left and right waterproof pouches when worn on the person's head and the left and right pouches are disposed adjacent to the person's ears to hold the speaker in place adjacent to the person's ear.

49. The head gear of claim 48 wherein the head engaging portion is a swim cap.
